(19) United States
(12) Patent Application Publication
(10) Pub. No.: US 2026/0260182 A1
(43) Pub. Date: Sep. 3, 2026

(54) SYSTEM AND METHOD

(71) Applicant: Matrix Booking Limited, London (GB)

(72) Inventors: Paul Denby Scott, Brookmans Park (GB); Scott Anthony Barden, Weybridge (GB)

(21) Appl. No.: 19/537,427

(22) Filed: Feb. 11, 2026

Related U.S. Application Data
(63) Continuation of application No. PCT/GB2024/052100, filed on Aug. 8, 2024.

(30) Foreign Application Priority Data
Aug. 11, 2023 (GB) 2312357.3

(51) Int. Cl. G06Q 10/0631; G06F 21/60

(52) U.S. Cl. CPC G06Q 10/0631; G06F 21/604

(57) ABSTRACT

This application relates to systems and methods for operating a system to control user rights to view data elements identifying physical resources shared by one or more organizations. The system comprises: a datastore; a processor; a graphical user interface: the datastore comprises a first dataset comprising first dataset elements identifying a first organization, a first parent physical resource, a first child physical resource of the first parent physical resource, the first dataset elements configured based on a first hierarchical relationship model, for representing the first child physical resources as being lower in the hierarchy than the first parent physical resource, and wherein the first dataset comprises location information of the physical resources of the first organization of the system. The system further comprises datastore comprising a second dataset comprising second dataset elements identifying a second organization, a second parent physical resource, a second child physical resource of the second parent physical resource, the second dataset elements configured based on a second hierarchical relationship model, for representing the second child physical resources as being lower in the hierarchy than the second parent physical resource and wherein the second dataset comprises location information of the respective physical resources of the second organization of the system. The method comprises: receiving a user input comprising information of the physical office resources to be shared by the one or more organizations; generating a sharing network configuration comprising rules for providing the user rights to view data elements identifying physical office resources shared by the one or more organizations based on the user input: determining a virtual location hierarchy responsive to the system receiving a request from a requesting user of the first organization to view data elements identifying physical office resources shared by one or more organizations, the determining comprising: generating, using the sharing network configuration and the second dataset, a third dataset comprising data elements identifying the physical office resources and associated locations shared by the second organization, wherein the identification is based on the second hierarchical relationship model and the third dataset is a subset of the second dataset; generating the virtual location hierarchy by combining the first and third datasets; and generating a graphical user interface to display the virtual location hierarchy for the requesting user to view data elements identifying physical office resources shared by one or more organizations on the graphical user interface.

### CROSS-REFERENCE TO RELATED APPLICATIONS

This application is a by-pass continuation of International Applicatoin No. PCT/GB2024/052100, filed Aug. 8, 2024, which claims priority to and the benefit of GB Patent Application No. 2312357.3, filed Aug. 11, 2023, both of which are herein incorporated by reference in their entireties.

### TECHNICAL FIELD

One or more embodiments in accordance with the present invention relate to systems and methods for controlling user rights to view data elements of a datastore. In particular, but not exclusively, to view data elements identifying physical office resources of a first organization made available for utilisation by, e.g. sharing with, a second organization in real time. Such embodiments may relate to “user reservation accessibility”, a term which in this context is used herein to refer to the ability for users to view one or more physical office resources. Physical office resources refer to physical assets of an organization such as, for example, buildings, floors within a building, meeting rooms, quiet rooms, desk space and such like. Sharing may include one or other or both of utilisation of and providing reservation access to the physical office resources and dependent on context may be synonmous and generally relate to the same thing. One or more embodiments may provide users with the ability to reserve the one or more physical office resources.

### BACKGROUND

Organizations are constantly on the lookout for more innovative and effective means to better utilize their office real estate whilst creating a safe and flexible working environment for their employees.

The resource use paradigm is the exclusive use of an organization's resources for its members. The exception being businesses whose business model is the renting of resources, for example serviced offices, hotels and the like. Outside of the resource renting paradigm cross-organizational sharing of office resources may be informal, ad-hoc arrangements to share resources between organizations or a more formal arrangement such as sub-letting.

Additionally, organizations are generally reluctant to permit access to their internal IT network system to users outside of their organization to avoid making them vulnerable to malicious hacking and non-employees gaining unlawful access to commercially sensitive information of the organization and/or causing commercial damage.

A system for sharing physical office resources and directed to room sharing within a single organization at the filing date of this patent application is implementable through Google™ calendar, more about which is findable at <https://support.google.com/a/answer/1034381?hl=en>, a copy of which is annexed to this application to be made available on the public file on and from the date of publication of this application, the contents of which are hereby incorporated by reference. The Google™ calendar implemented system allows a resource calendar to be shared publicly or with specific external individuals via their email address. It does not support more generic sharing, such as to all users with a particular email domain. Non-employees are unable to view availability and/or reserve access to these resources.

Another such system for sharing resources directed to making an organization's resource sharable by its employees is implementable through Microsoft 365™, more about which is findable at <https://learn.microsoft.com/en-us/microsoft-365/admin/manage/room-and-equipment-mailboxes?view=o365-worldwide>, a copy of which is annexed to this application to be made available on the public file on and from the date of publication of this application, the contents of which are hereby incorporated by reference. The Microsoft 365 system requires a sharer to create a mailbox for the shared resource which the sharer can then use to invite a person or a “sharee” from another organization to book and use the shared resource. This approach does not provide the sharee visibility of all the shared resources available.

Aspects and embodiments in accordance with the present invention have been devised with the foregoing in mind.

### SUMMARY OF THE INVENTION

The appended claims may serve to summarize the disclosure. Viewed from a first aspect there is provided a method for operating a system to control user rights to view data elements identifying physical resources shared by one or more organizations. The method comprises: storing in a datastore of the system, a first dataset comprising first dataset elements identifying a first organization, a first parent physical resource, a first child physical resource of the first parent physical resource, the first dataset elements configured based on a first hierarchical relationship model, for representing the first child physical resources as being lower in the hierarchy than the first parent physical resource, and wherein the first dataset comprises location information of the physical resources of the first organization of the system. The method further comprises storing in the datastore of the system, a second dataset comprising second dataset elements identifying a second organization, a second parent physical resource, a second child physical resource of the second parent physical resource, the second dataset elements configured based on a second hierarchical relationship model, for representing the second child physical resources as being lower in the hierarchy than the second parent physical resource and wherein the second dataset comprises location information of the respective physical resources of the second organization of the system.

Viewed from a second aspect there is provided a method for operating a system to control user rights to view data elements identifying physical resources shared by one or more organizations. The system comprises: a datastore; a processor; a graphical user interface: the datastore comprises a first dataset comprising first dataset elements identifying a first organization, a first parent physical resource, a first child physical resource of the first parent physical resource, the first dataset elements configured based on a first hierarchical relationship model, for representing the first child physical resources as being lower in the hierarchy than the first parent physical resource, and wherein the first dataset comprises location information of the physical resources of the first organization of the system. The system further comprises datastore comprising a second dataset comprising second dataset elements identifying a second organization, a second parent physical resource, a second child physical resource of the second parent physical resource, the second dataset elements configured based on a second hierarchical relationship model, for representing the second child physical resources as being lower in the hierarchy than the second parent physical resource and wherein the second dataset comprises location information of the respective physical resources of the second organization of the system. The method comprises: receiving a user input comprising information of the physical resources to be shared by the one or more organizations; generating a sharing network configuration comprising rules for providing the user rights to view data elements identifying physical resources shared by the one or more organizations based on the user input: determining a virtual location hierarchy responsive to the system receiving a request from a requesting user of the first organization to view data elements identifying physical resources shared by one or more organizations, the determining comprising: generating, using the sharing network configuration and the second dataset, a third dataset comprising data elements identifying the physical resources and associated locations shared by the second organization, wherein the identification is based on the second hierarchical relationship model and the third dataset is a subset of the second dataset; generating the virtual location hierarchy by combining the first and third datasets; and generating a graphical user interface to display the virtual location hierarchy for the requesting user to view data elements identifying physical resources shared by one or more organizations on the graphical user interface.

Viewed from a third aspect there is provided a system for controlling user rights to view data elements identifying physical resources shared by one or more organizations. The system comprises: a datastore; a processor; a graphical user interface; the system configured to: store in a datastore of the system, a first dataset comprising first dataset elements identifying a first organization, a first parent physical resource, a first child physical resource of the first parent physical resource, the first dataset elements configured based on a first hierarchical relationship model, for representing the first child physical resources as being lower in the hierarchy than the first parent physical resource, and wherein the first dataset comprises location information of the physical resources of the first organization of the system; store in the datastore of the system, a second dataset comprising second dataset elements identifying a second organization, a second parent physical resource, a second child physical resource of the second parent physical resource, the second dataset elements configured based on a second hierarchical relationship model, for representing the second child physical resources as being lower in the hierarchy than the second parent physical resource and wherein the second dataset comprises location information of the respective physical resources of the second organization of the system; receive a user input comprising information of the physical resources to be shared by the one or more organizations; generate a sharing network configuration comprising rules for providing the user rights to view data elements identifying physical resources shared by the one or more organizations based on the user input: determine a virtual location hierarchy responsive to the system receiving a request from a requesting user of the first organization to view data elements identifying physical resources shared by one or more organizations, the determining comprising: generating, using the sharing network configuration and the second dataset, a third dataset comprising data elements identifying the physical resources and associated locations shared by the second organization, wherein the identification is based on the second hierarchical relationship model and the third dataset is a subset of the second dataset; generating the virtual location hierarchy by combining the first and third datasets; and generating a graphical user interface to display the virtual location hierarchy for the requesting user to view data elements identifying physical resources shared by one or more organizations on the graphical user interface.

The system provides a secure and purpose-designed physical resource sharing systems and methods (i.e. to aid transition from conventional single private tenant network to open multi-tenant network) to enable multiple organizations to better utilise their surplus resources in a secure and hassle-free manner. Absent of such a resource sharing system, surplus resources within organizations

are left perpetually empty and underutilised. When a request is processed, a traditional multi-tenanted SaaS system without a sharing network configuration may typically check that the data elements being manipulated or requested belong to the appropriate user's organization. However, one or more embodiments in accordance with the present system extend this functionality by considering whether the booking-related action, such as searching for available resources, booking a shared resource, or making subsequent changes to data elements, belongs to another organization. If so, the system checks whether the user's organization has been granted access via the sharing network configuration. Therefore, enhancing the security capabilities of the system in an efficient manner without the need to check individual data elements.

One or more embodiments in accordance with the invention were devised with the foregoing in mind.

Other aspects will be in part apparent and in part pointed out hereinafter.

### BRIEF DESCRIPTION OF THE DRAWINGS

One or more embodiments in accordance with the invention will now be described, by way of non-limiting example only, and with reference to the accompanying drawings, in which:

FIG. 1 is a schematic diagram of an illustrative implementation of the proposed physical office resource sharing system 100;

FIG. 2(a) illustrates an example hierarchical relationship of automotive components adopting the nested set “left/right” numbering sequence;

FIG. 2(b) is a table detailing the nested set numbering sequence for each element of the hierachy associated with the example in FIG. 2(a);

FIG. 3 illustrates another example hierachical relationship of the physical office resources of an organization B based on the nested set model;

FIG. 4 is a schematic illustration of the physical resource sharing example for embodiment example 1;

FIG. 5 is the GUI of an example embodiment and illustrates how the system can be utilized to establish a sharing network between organizations involved in embodiment example 1;

FIG. 6 illustrates the GUI of an example embodiment and illustrates how the sharing network between the organizations in embodiment example 1 is accessible and editable by an organization administrator;

FIG. 7 is a schematic illustration of the desired sharing configuration between organizations A and B for embodiment example 1;

FIG. 8 is a schematic illustration of the sharing network configuration for embodiment example 1;

FIG. 9 illustrates a process flow diagram for generating a virtual location hierachy VLH for embodiment example 1;

FIG. 10 is a schematic illustration of how dataset 3 can be generated;

FIG. 11 is a schematic illustration of how dataset 4 can be generated;

FIG. 12 ilustrates the inputs and process steps executed by the system to generate a VLH for a requesting user from organization A;

FIG. 13 illustrates an example of how booking resource categories may be consolidated between sharing organizations;

FIG. 14 illustrates a process flow diagram of how booking resource categories may be consolidated between sharing organizations;

FIG. 15 illustrates how a requesting user from an organization is provided with functionality to view and search the available physical office resources via an example GUI;

FIG. 16 is a schematic illustration of the physical resource sharing example for embodiment example 2;

FIG. 17 is a schematic illustration of the first sharing network configuration required to achieve the desired resource sharing for embodiment example 2;

FIG. 18 is a schematic illustration of the second sharing network configuration to achieve the desired resource sharing for embodiment example 2;

FIG. 19 illustrates how the system generates a custom VLH for user of organization A in embodiment example 2;

FIG. 20 depicts the GUI of an example embodiment and illustrates how a second the system can be utilized to establish a security group for users of an organization; and

FIG. 21 depicts a conceptual view of the hierarchical “slice”.

### DETAILED DESCRIPTION

In the following description, for the purposes of non-limiting explanation only, numerous specific details are set forth to provide a thorough understanding of the present disclosure. In other instances, well-known structures and devices are shown in block diagram form to avoid unnecessarily obscuring the present disclosure.

Embodiments are described in sections below according to the following outline:
Glossary
System overview
Hierarchical structure of physical office resources of an organization
Embodiment Example 1—controlling user accessibility to physical office resources shared between two organizations
Creating a sharing network configuration
Consolidation of booking categories
Embodiment Example 2—controlling user accessibility to physical office resources shared between four organizations
Other variants

### Glossary

The following definitions apply to the terminology used in the illustrative embodiments described herein to provide examples of implementations of the inventive concepts and are non-limiting definitions in relation to the scope of application of the inventive concepts as defined by the appended claims.

Providing user accessibility: this expression refers to providing users the ability to view and/or reserve set time periods for use of one or more physical office resources.
Share: this term refers to providing user accessibility across organisations.
Sharable: this term describes physical office resources belonging to one or more organization that are made available for utilisation by other organisations.
Users: This Generally Refers to Anyone From Any of the Organizations That can access the system.
Physical office resource (used interchangeably with “resource”): this expression refers to physical assets of an organization such as, for example, buildings, floors within a building, meeting rooms, quiet rooms, desk space and such like. It can also refer to other assets such as staff, company vehicles, parking bays, or IT equipment.
Location: this term refers generally to information about the geographical location of a physical office resource, for example, a road name, building name, address, longitudinal and latitudinal coordinates.
Organization (or org): this term refers to a group of natural and/or legal persons operating in accordance with a system of business rules and/or regulations, using the physical office resource sharing service system.
Organization administrator: this refers to a person designated by an organization who determines what physical office resource within an organization they are administrator for can be shared and who within the organization can view and or get access to physical office resources shared by other organizations.
Virtual Location Hierarchy VLH: this refers to a combined hierarchy of resources shared by multiple organizations, generated at the time of use of the system.
Runtime: this term refers to calculations that are performed synchronously at the time of use. This term is synonymous to real time.
Sharing network configuration: this refers to the specific conditions under which the various physical office resources are being shared by the participating organizations.
Super administrator(s): this refers to a person in a third-party organisation who possess the rights to set up a sharing network configuration between organizations of the physical office resource system.
Booking categories: this term refers to the different types or groups of physical office resources shared by the different organizations, such as desks, meeting rooms and floors etc.

### System Overview

Systems and methods for enabling multiple organizations to make their physical resources available for users of the other organizations to access (i.e., users to view or search and reserve) in accordance with one or more embodiments of the invention will now be described. In one or more embodiments, the physical resources of the respective organizations may be physical office resources. It will be appreciated that the said physical resources may relate to any suitable physical resource other than physical office resources. Titles, sub-titles, headings and so forth are for the convenience of the reader and are non-limiting.

In one embodiment, the proposed physical office resource sharing system facilitates resource sharing between two organizations and is implemented in software on a standalone computing system coupled to a network. Participating organizations can access this service by accessing the software within the standalone computing system via the network.

In another embodiment, the proposed physical office resource sharing system facilitates resource sharing amongst multiple organizations and is implemented in software on a distributed computing system comprising a webserver computer coupled via a network to a host computing device. The distributed computing environment can be within one or more data centre, virtual computing facility or other hosting facilities connected to a network such as, for example, the Internet or other network; other embodiments can be within a networked home, office, or campus.

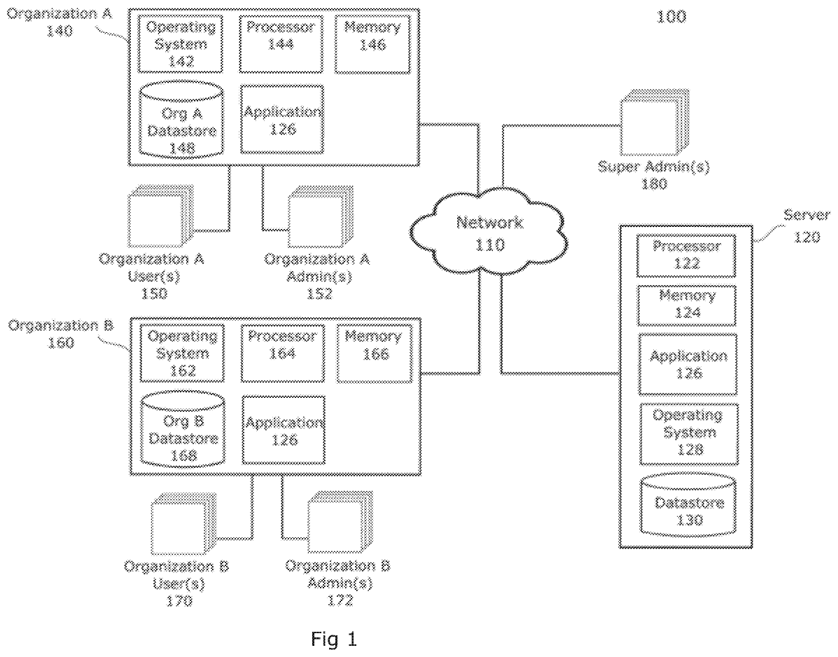

FIG. 1 is a schematic diagram of an illustrative implementation of the proposed physical office resource sharing system 100. The embodiment illustrated in FIG. 1 shows a system configured to allow two organizations, Organization A (Org A) 140 and Organization B (Org B) 160, to view and manipulate data elements identifying physical office resources of a first organization made available for utilisation, e.g., sharing, by a second organization in real time.

The computer program instructions that implement the system depicted in FIG. 1 may be executed on one or more processing apparatus such as the server processor 122 and/or the organization processors 144/164. These instructions may be embodied as an application, for example, an application 126. The application 126 may be stored in any suitable location and the application invocable by a user through any suitable device, for example, the application 126 may be invoked by a user computing device such as a desktop computer, mobile device, tablet, or any such device over a network 110 by invoking, for example, a browser application, desktop application, or any suitable application through the user computing device.

In one or more embodiments the application 126 may be stored within the computing devices belonging to each organization and on the server 120. The application comprises a suite of functionalities. However, the application's functionality may vary depending on the user's level of authority which will become clear in the following passages. Regardless of the level of authority, the application provides a seamless, user-friendly experience.

In system 100 of FIG. 1, the computing resource relied upon by users of organization A are represented by an organization A 140 in FIG. 1, which comprises an operating system 142, a processor 144, a memory 146, an organization A datastore 148, and an application 126. The operating system 142 may be specific to Windows OS, macOS, or Unix/Linux, among others. The operating system may be configured to communicate with the processor 144, memory 146, datastore 148, and the application 126 of organization A. The processor 144 is configured to execute executable instructions (e.g., programs). In some embodiments, the processor 144 comprises circuitry or any processor capable of processing executable instructions communicated to the processor by the application 126, and operating system 144. Also forming part of the organization A computing resources are further processing elements such as memory which may comprise read only memory and random—access memory. The organization A datastore 148 stores data elements comprising the physical office resources of organization A amongst other data elements. These data elements may also be stored in a server datastore 130. The application 126 comprises the software elements of the physical office resource system, for example a graphical user interface (GUI), and the application 126 may be configured to communicate with the operating system 142, processor 144, memory 146, and datastore 148 of organization A 160. The application 126 in organization A may further be suitably configured to establish communication with the application 126 hosted on the server 120 through the network 110. An organization A user(s) 150 and an organization A admin(s) 152 can interact with the server 120 by utilising organization A 140 computing resources, for example via a GUI as part of a computing device on the network 110, where the computing device may be a desktop computer, a mobile device, among others, and the GUI may form part of the application 126, where the application may be a web application, a mobile application, among others. In this way the user(s) 150 can view data elements in a server datastore 130 through communicating with the application 126 on the server 120 via the application 126 in organization A 140. The admin(s) 152 may likewise view data elements in a server datastore 130. Additionally, the admin(s) 152 may assign which data elements belonging to organization A stored in the organization A datastore 148 or the server datastore 130 are made available for utilisation to users of a second organization such as organization B users 170.

The computing resource relied upon by members of organization B 160 is the same as that for organization A 140. For the sake of completeness, the computing resource of Organization B comprises an operating system 162, a processor 164, a memory 166, an organization B datastore 168, and an application 126. The operating system 162 may be specific to Windows OS, macOS, or Unix/Linux, among others. The operating system may be tailored to communicate with the processor 164, memory 166, datastore 168, and the application 126 of organization B. The processor 164 is configured to execute executable instructions (e.g., programs). In some embodiments, the processor 164 comprises circuitry or any processor capable of processing executable instructions communicated to the processor by the application 126, and operating system 162. Also forming part of the computing resource of organization B are further processing elements such as memory 166 which may comprise read only memory and random-access memory. The organization B datastore 168 stores data elements comprising the physical office resources of organization B amongst other data elements. These data elements may also be stored in a server datastore 130. The application 126 comprises the software elements of the physical office resource system, for example a GUI, and the application may be configured to communicate with the operating system 162, processor 164, memory 166, and datastore 168 of organization B 160. The application 126 in organization B may further be suitably configured to establish communication with the application 126 hosted on the server 120 through the network 110. An organization B user(s) 170 and an organization B admin(s) 172 can interact with the server 120 via for example a GUI as part of a computing device on a network 110, where the computing device may be a desktop computer, a mobile device, among others, and the GUI may form part of the application 126, where the application may be web application, a mobile application, among others. In this way, the user(s) 170 can view data elements in a server datastore 130 through communicating with a server application 126 via the application 126. The admin(s) 172 may likewise view data elements in the server datastore 130. Additionally, the admin(s) 172 may assign which data elements belonging to organization B stored in the organization B datastore 168 or the server datastore 130 are made available to users of a second organization such as organization A 150.

In the proposed system 100, the organization computing resources, that is, organization A 140 and organization B 160 in this example embodiment, are connected via the network 110 to the server 120, which comprises a processor 122, a memory 124, an application 126 hosted on the server, an operating system 128, and a server datastore 130. The operating system 128 may be specific to Windows OS, macOS, or Unix/Linux, among others. The operating system 128 may be tailored to communicate with the processor 122, memory 124, datastore 130, and the application 126 hosted on the server 120. The server 120 as implemented in this example embodiment is remote from organization A 140 and organization B 160, and for example, in communication with the clients via a network 110 which can be a wired or wireless communication network such as a local area network, a wide area network, or the internet embodied, for example, as a cloud-based server. The application 126 of, for example, organization A 140 may be configured to communicate with the application 126 hosted on the server 120 and may register for notifications from the application 126 hosted on the server. Furthermore, the application 126 in organization A may communicate data regarding activity of an organization A user(s) 150 to the application 126 hosted on the server for monitoring, compliance, processing etc. The server 120 may store the activity data or physical office resource data in a datastore 130. The datastore 130 may be located at remote data centres, for example, in a cloud storage. The server processor 122 is configured to execute executable instructions (e.g., programs). In some embodiments, the server processor 122 comprises circuitry or any processor capable of processing the executable instructions communicated by a respective organization user(s) 150, 170, a respective organization admin(s) 152, 172, or a super administrator(s) 180. The super administrator(s) 180 can permit/set up a sharing network between participating organizations. For example, the super administrator(s) 180 may permit organization B to view data elements of organization A.

While FIG. 1 illustrates a single system server 120, the server 120 may be distributed across two or more physical server devices. Likewise, the server datastore 130 may be distributed across two or more physical storage devices.

The organization users such as an organization A user(s) 150 may transfer and store user data in encrypted form due to sensitivity of information. For example, the data transferred from the application 126 in an organization to the application 126 hosted on the server may be encrypted, data transferred from the application 126 hosted on the server to the application hosted in an organization 126 may be encrypted, and data elements stored in the organization A datastore 148 and/or the server datastore 130 may be encrypted, for example using standard encryption methods like AES protocol or other encryption methods.

Such an implementation may be considered to provide a multi-tenanted software-as-a-service (SaaS) application where each organization has a tenant that is accessed through the application 126; and where users, configuration and data elements are logically separated from and not accessible by other users of other organizations.

The proposed sharing system modifies the standard multi-tenant SaaS model paradigm to allow an organization to selectively share data elements representative of locations and resources with other organizations, allowing these other organizations to view the shared data elements as though they were their own.

The foregoing are merely example methods of implementation, other implementations of working the invention may be envisaged.

### Hierachical Structure of Physical Office Resources of an Organization

In one or more embodiments, each organization has its own suite of digital representations of physical office resources that are organised in a hierarchical structure, for example, multiple buildings in different locations, multiple floors within one or more of the buildings, one or more meeting rooms, desks and the like within one or more of the floors. The described system enables resource sharing by identifying the type and location of each physical office resource while preserving the hierarchical relationships of the physical office resources. In the example embodiments described herein, a nested set model is used to represent the physical office resources. The nested set model is a known hierarchical relationship model. It will be understood that any suitable hierarchical relationship model can be used to represent the physical office resources. These may include nested interval models, adjacency list models, path enumeration models, closure table models, amongst other suitable models.

### The Nested Set Model

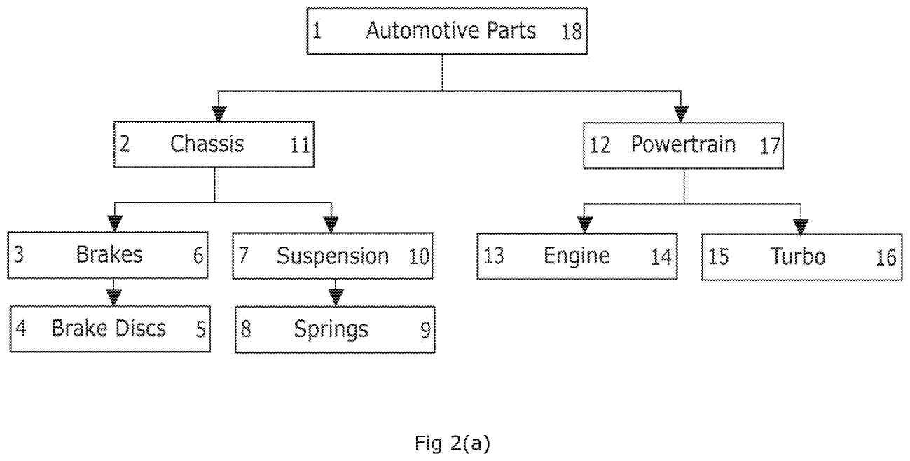

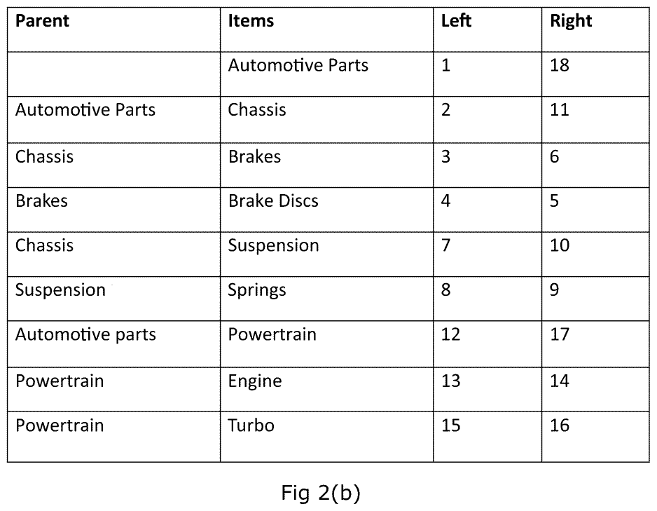

An example of how a nested set model can be used is illustrated in FIG. 2a which represents a hierarchical relationship of automotive components. The nested set model applies a “left/right” numbering sequence to nodes within a hierarchy to derive parent/child/sibling/grandchild etc. relationships. A node's left value is always less than its right value. A node's left and right values do not overlap with a sibling node's values. A node's direct and indirect child nodes will have a left value greater than its own and a right value less than its own, see FIG. 2b A node's direct and indirect parent nodes will have a left value less than its own and a right value greater than its own.

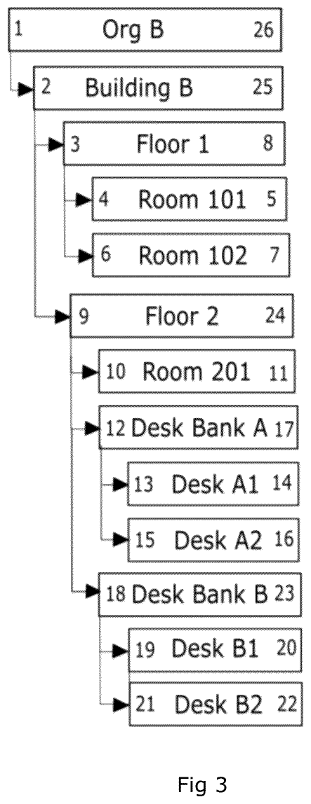

FIG. 3 illustrates an example of how a nested set model can be used to represent the hierarchical structure of physical office resources of organization B in an embodiment of the present invention. As the Fig shows, the left/right numbering sequence assigned to resources within the hierarchy of organization B obeys the nested set model as discussed in the preceding section.

The hierarchical relationship example illustrated in the embodiment in FIG. 3 may be encoded into the proposed resource sharing system where each physical office resource is assigned a unique data element, i.e., an identifier. In the example embodiment in FIG. 3, the data elements of the physical office resources, which preserves the hierarchical relationship of the organization B's resources, may comprise any one or more of: an element id; a left value and a right value in accordance with the nested set model numbering sequence; and a physical office resource category, for instance a building, floor, among other resource categories. The concept of resource categories will be discussed in further detail below.

### Embodiment Example 1—Controlling User Accessibility to Physical Office Resources Shared Between Two Organizations

Purely for illustrative purposes, an example embodiment comprising two organizations sharing respective physical office resources will now be described using the described physical resource sharing system 100. This example embodiment enables users belonging to two organizations, organization A and organization B, the ability to view and manipulate shared physical office resources belonging to these organizations. In the example embodiment, organization A is configured to enable data elements of their respective physical office resources to be viewable by user(s) of organization B 170.

### Super Administrator

In order not to allow any one organization to have full visibility of another organization's physical office resources, there is provided a third party, central governing body to collate and manage the data sets from the various organization. This is to create a secure environment to prevent or at least inhibit snooping from participating organizations A and B taking part in the illustrated embodiment. This obviates the need for providing participating organizations' administrators with access to other participating organizations' computing resources.

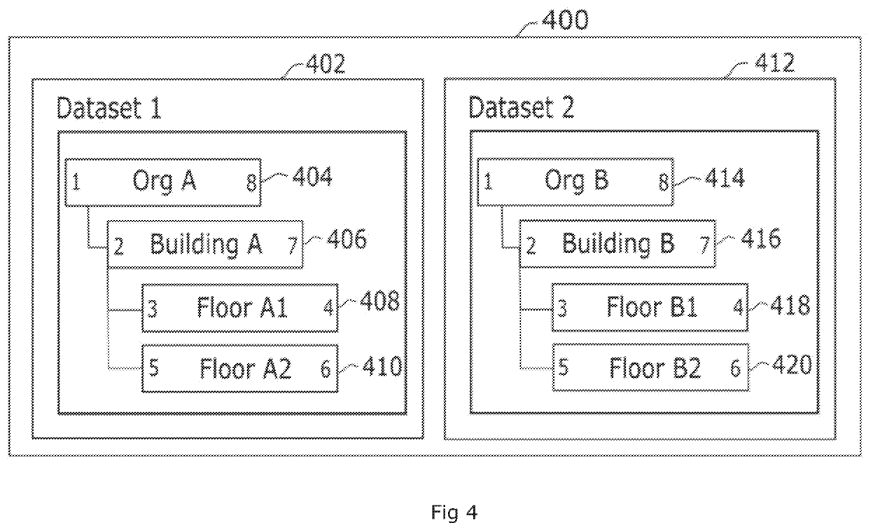

Turning now to FIG. 4, in one or more embodiments the physical office resources of organization A 404 are organised in a hierarchical structure comprising the parent resource building A 406, and the child resources two floors, floors A1 408 and A2 410, located within building A 406. The physical office resources of organization B 414 are also organised in a hierarchical structure comprising building B 416 as the parent resource and two floors, floors B1 418 and B2 420, the child resources, located within building B 416. In FIG. 4, the hierarchical relationship of the resources of organizations A and B are both represented in dataset 1 402 and dataset 2 412 as data elements using the nested set model and stored in the server datastore 130 of the proposed system. The datasets 1 402 and 2 412 may also be stored in the organization A datastore 148 and in the organization B datastore 168 respectively.

### Creating a Sharing Network Configuration

In one embodiment the super administrator creates an initial sharing network configuration where the sharing network configuration captures the specific conditions under which the various physical office resources are being shared by the participating organizations. At this stage, no physical office resources have been shared yet. The initial sharing network configuration merely show which organizations are participating in the sharing, in this example, organizations A and B. The super administrator 180 implements this by accessing the server datastore 130 using the application 126 hosted on the server 120 to selectively designate which data elements are made visible to participating organizations within the sharing network.

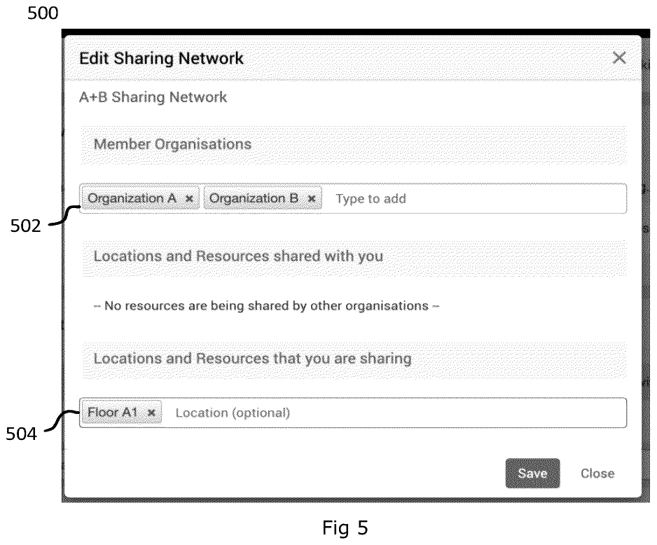

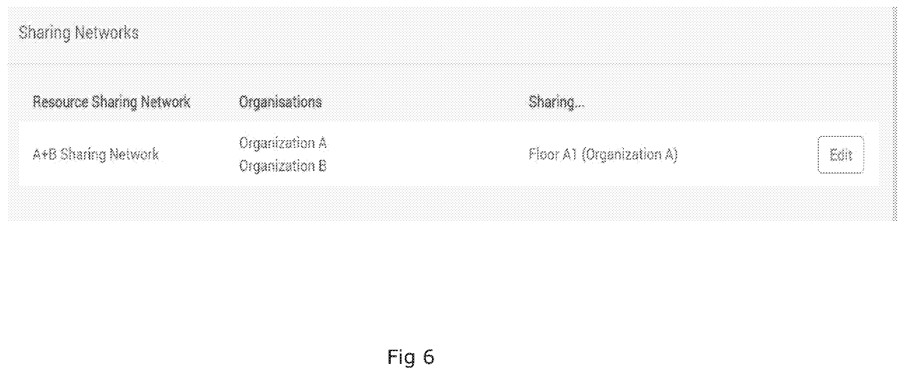

FIG. 5 depicts the GUI of an example embodiment and illustrates how the system can be utilized to establish a sharing network between organization A and organization B. In FIG. 5, the super administrator 180 enters the organizations participating in the sharing network using element 502 of the GUI. It will be appreciated that, in one or more embodiments, the super administrator(s) 180 has access to functionality in the application 126 to generate more than one sharing network to facilitate the requirements of the sharing agreement between multiple organizations. The sharing network between organization A and B is accessible to the user on the GUI in FIG. 6.

In the following example embodiment, organization A aims to permit users of organization B to utilize floor A1 of building A. Notably, in this example embodiment, organization B is not sharing any physical office resources with users of organization A. Such a configuration enables unilateral sharing, wherein only one organization shares resources. It will be appreciated that the system is not confined to a unilateral sharing network configuration and can facilitate multilateral sharing network agreements between participating organisations. Advantageously, this feature provided by the system offers flexibility and customization to meet the diverse needs of various organizations.

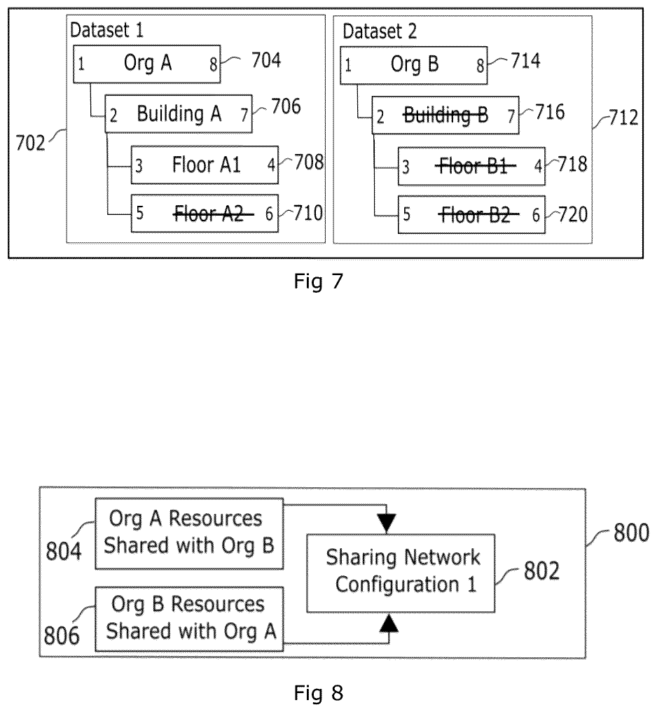

A unilateral sharing relationship is illustrated in FIG. 7, where physical office resources not shared by both organizations, that is, floor B1 718, floor B2 720 of building B 716, and floor A2 710 of building A 706 are selectively removed from being viewed through the system application 126 which does not retrieve and/or display data elements which are not shared between organizations, depending on which user makes the request. In this way organization A and organization B have set up their respective sharing arrangements with respect to each other.

### Modifying the Sharing Network Configuration

Steps for enabling use of the sharing configuration of the embodiment illustrated in FIG. 7 by users of the system of 100 are now described with reference to FIG. 5. The user modifying the sharing configuration may have specific administrative rights additional to ordinary user rights to avoid system abuse and maintain commercial privacy amongst the organizations. This user may be from an organization or a super administrator. For example, an organization A administrator(s) 152, an organization B administrator(s) 172, or a super administrator(s) 180 decides which and how the physical office resources should be shared amongst the organizations.

The sharing intentions of organization A and B in the example embodiment illustrated in FIG. 7, are encoded into the system via the GUI of application 126 in the organization by the administrator user for the respective organisations and/or the super administrator. For example, the organization A administrator(s) 152 accesses the physical office resource data elements of dataset 1 702 stored in the server datastore 130 and selects the locations and resources that are to be shared by organization A with organization B, via a GUI (see 504). If, in another embodiment, organization B wanted to share their resources with organization A then the organization B administrator(s) 170 may access the physical office resource data elements of dataset 2 712 stored in the server datastore 130 and select the resources that are to be shared by organization B with organization A using the GUI illustrated in FIG. 5 The modified sharing network configuration may be stored in the server datastore 130 and/or the respective organization datastores 148, 168.

### Concept of a Hierarchical “Slice” of an Organizations Physical Office Resource Hierarchy

When a physical office resource, for example a floor of a building, is shared with other organizations, the physical office resource hierarchically above the shared floor, for example the building containing the floor, (i.e. the parent of the child) may also be accessed by one or more users of the other organizations within the sharing network configuration 802, illustrated in FIG. 8. If the hierarchy contains ancestor physical office resources directly above the parent resource, these may also be accessed by the one or more users of the other organizations. However, they may not have access to the other non-shared locations within building A, such as floor A2 in example embodiment 1.

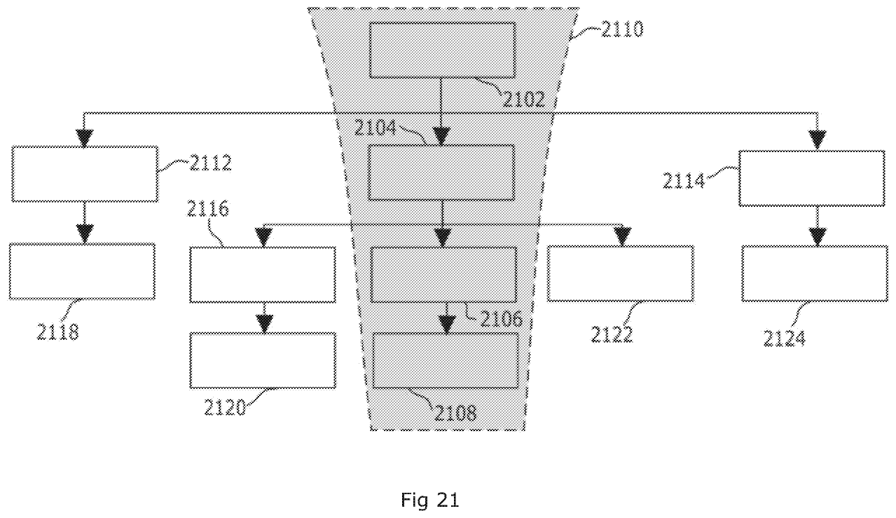

For example, in the embodiment depicted in FIG. 21, if the physical office resource represented by the element 2106 is shared with the one or more users from other organizations, they will also have access to the physical office resources ‘upstream’ represented by the elements 2102, 2104. In addition, they will also have an access to physical office resources ‘downstream’ represented by element 2108, which together constitute a conceptual hierarchical “slice” 2110 of the organization's physical office resources hierarchy that are shared with other organizations. It will be appreciated that the non-shared physical office resources denoted by elements 2112, 2114, 2116, 2118, 2120, 2122, and 2124 may remain inaccessible to these one or more users.

These conceptual hierarchical “slices” 2110 are dynamic in that they are generated for a particular user of an organization in response to a user making a request to the system to view and access shared resources. As such, the contents within the slice may change depending on what resources are available at the point in time the slice was generated (time of request to view and or access).

### Generating the Virtual Location Hierarchy VLH

A user from organization B may desire to view and/or book a physical office resource from the pool of resources made available to view and book by both organizations A and B.

To access these resources, the user logs into or initiates the system via a browser or application. The application can take various forms, including a mobile app for iOS or Android, a Microsoft Outlook add-in for Windows, or an add-in for Microsoft 365, among others.

When the user sends a request to the system, such as via the web browser or application, the system generates a real-time view of available resources that is tailored to the user's request. Depending on the user type (i.e. access levels of the users), the user sees a different view of resources available to them from another user with a different access level.

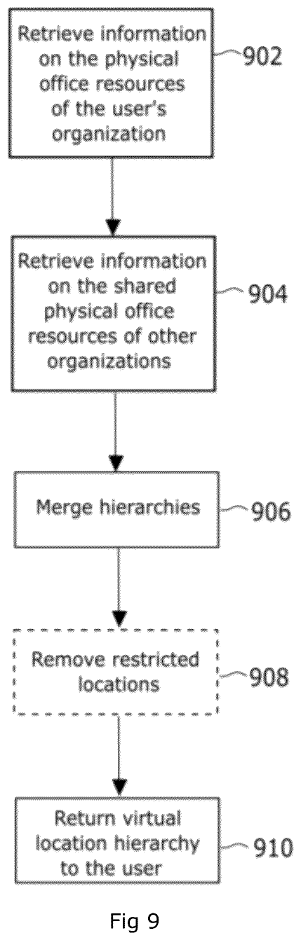

The steps necessary by the system to execute the above function are shown in the process flow control diagram of FIG. 9 and described in further detail below.

At step 902, when a user from organization B initiates a request to view and book available resources through the system 100 by, for example, logging into/loading the application 126, the dataset 2 is retrieved from the server datastore 130 in response. Dataset 2 contains data elements representing the physical office resources belonging to organization B, that is for example, the resource categories, the hierarchical relationships, and the locations of the resources in organization B in FIG. 4.

If a user from organization A initiates a request to view what resources are available to view and book, then at step 902, the system will retrieve and load dataset 1 from the datastore.

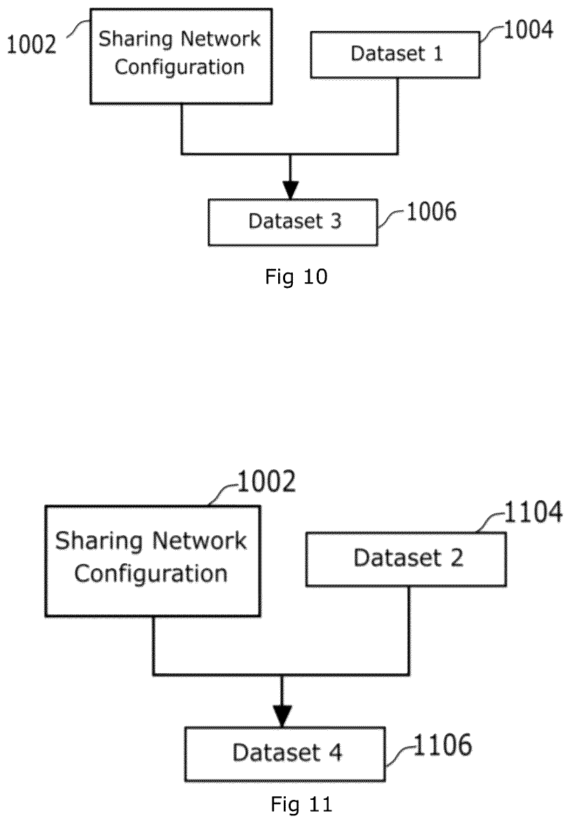

At step 904, for a user of organization B the system retrieves from dataset 1 data elements representing the physical office resources that are being made available for view by organization A with organization B based on the sharing rules defined within the sharing network configuration as shown in FIG. 10. Dataset 3 1006 is a subset of dataset 1 1004 and the system 100 determines Dataset 3 using the resource sharing rules defined in the sharing network configuration 1002.

This is because only those physical office resources organization A has agreed to be utilisable by users belonging to organization B will be visible i.e., in this example, shared “slice” building A, floor A1. The system extracts only those data elements within dataset 1 1004 that are being shared to generate dataset 3 1006 which is stored in the server datastore 130.

Likewise, if a user from organization A initiates a request to view what resources are available to view and book, then at step 904, the system will identify and retrieve from dataset 2, 1104, data identifying the physical office resources currently made available by organization B to view and/or reserve, based on the sharing rules defined within the sharing network configuration 1002 as shown in FIG. 11. The system extracts only those data elements within dataset 2, 1104 that are designated as shareable to generate dataset 4 1106 which is stored in the server datastore 130.

At step 906, for a user of organisation B, the system merges dataset 2 and dataset 3 to create a new dataset 5 which may be stored in the server datastore 130 comprised of information of the physical office resources available to the user of organization B to view and book (i.e. access to all resources within organization B but a hierarchical “slice” of organization A, which includes building A and floor A1)

In at least one embodiment, at step 908 (optional step) any resources that the user does not have access to are removed as per direct or indirect security group restrictions. This step is optional and is performed by an organization or super administrator(s) via the GUI as part of the organization and server application respectively.

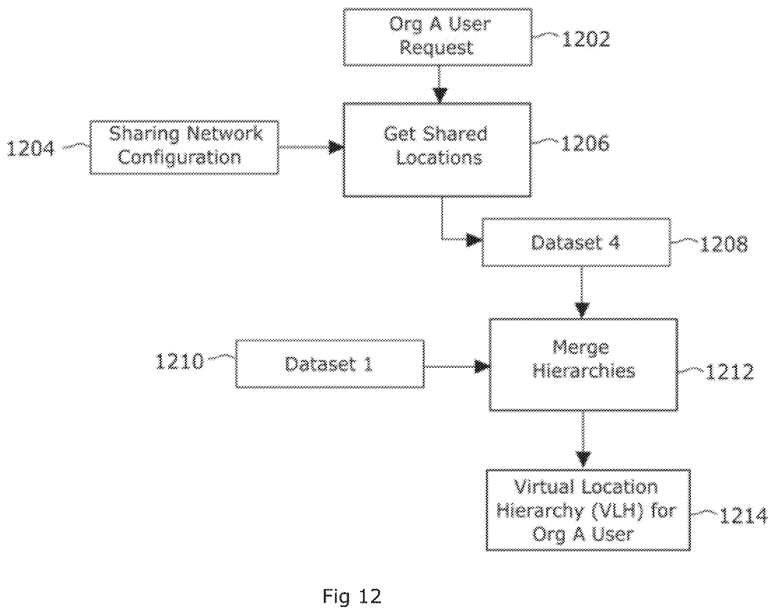

At step 910, the virtual location hierarchy, which comprises the merged datasets at step 906 and may optionally include further step 908 if the security group restriction is implemented, is output to the user via a GUI, FIG. 12 illustrates the various inputs and process steps executed by the system to generate the VLH for the user of organization A in this example.

By way of the system generating the VLH and therefore the “hierarchical slice” an access environment is created in which the requesting user may view and access only those resources that are being shared by one or more organizations. Resources not being shared are not visible to the user. Moreover, as the slice is generated at runtime, any changes to the availability of shared physical office resources or if one or more resources are no longer being shared, are automatically updated when the VLH is generated. The user therefore has visibility of and access to the most up-to-date availability status of the shared resources. Additionally, by way of the VLH the visibility of the hierarchical slice inherently includes the location information of the shared resource. This enables the requesting user to quickly identify where a particular shared office resource is physically located.

### Consolidation of Booking Resource Categories

In the described system, the different types of physical office resources shared by the different organizations, such as desks, meeting rooms and floors are each identified as a separate “booking category”. Within each booking category, for example, “meeting rooms”, there may be more than one of the same type of resource being shared, in this case meeting rooms. Such resources are configured separately for each organization and therefore they may have different names because respective organisations may have their own way of naming their office resources.

The consolidation of booking categories enables only relevant physical office resources to be accessible to the requesting user. This has the effect of allowing the user to more quickly and easily select a desired physical office resource within a particular booking category.

In one or more embodiments, the system responds to user commands via a GUI as part of the application 126. In such one or more embodiments, the system identifies and generates a set of possible booking categories in a manner that avoids displaying the same logical category to the user multiple times. The system 100, responsive to a command, compares and matches commonalities between naming conventions of different organizations by name-matching the name of the physical office resources with a look-up table. When the system identifies data elements referring to the same category the application 126 consolidates the set of possible booking categories.

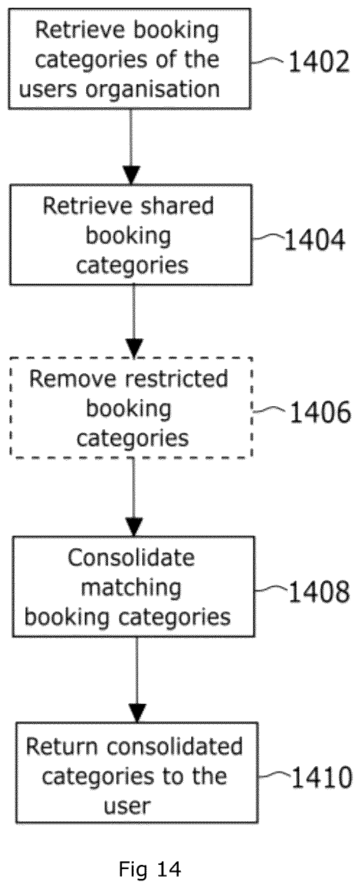

In accordance with one embodiment, the system performs these functions by following the process flow control steps illustrated in FIG. 14. This approach improves the user experience by effectively hiding the sharing network configuration nuances from the user, allowing them to quickly and efficiently find a physical office resource that meets their needs.

At step 1402, the system, via the server 120 and responsive to actuation of command input by the user of an organization requesting to view shared resources, retrieves the booking resource categories of the requesting user's organization located in the dataset stored within the server datastore 130.

At step 1404, the system utilises the sharing network configuration generated to retrieve the physical office resources shared by other organizations as respective datasets stored in the datastore 130 and thereby, identifying the booking resource categories made available to this user by other organizations.

In at least one embodiment, at step 1406, booking categories the requesting user is not allowed to view and access are withheld from view by an admin user(s) via the GUI as part of the application 126. This further step provides the additional feature of removing from view to the user certain booking categories that may be of a sensitive or not applicable in nature. In this case, the user will not be able to view all the physical office resources within this category. This feature is not essential to an implementation of embodiments in accordance with the invention. The system may work with or without it. Implementation of this feature may be found under the discussion of variants below.

At step 1408, the system identifies identical booking categories and consolidates them by searching for data elements that represent physical office resources with the same underlying type, such as a desk. It then searches for physical resource types with matching names before consolidating the office resources for the user.

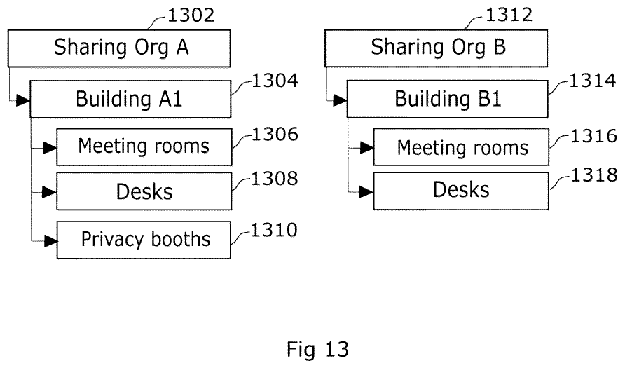

At step 1410 in FIG. 14, the system outputs the identified booking resource categories to the user. In the example in FIG. 13, this would be “meeting rooms”, “desks” and “privacy booths”.

### Viewing and Booking the Physical Office Resources Using the Graphical User Interface

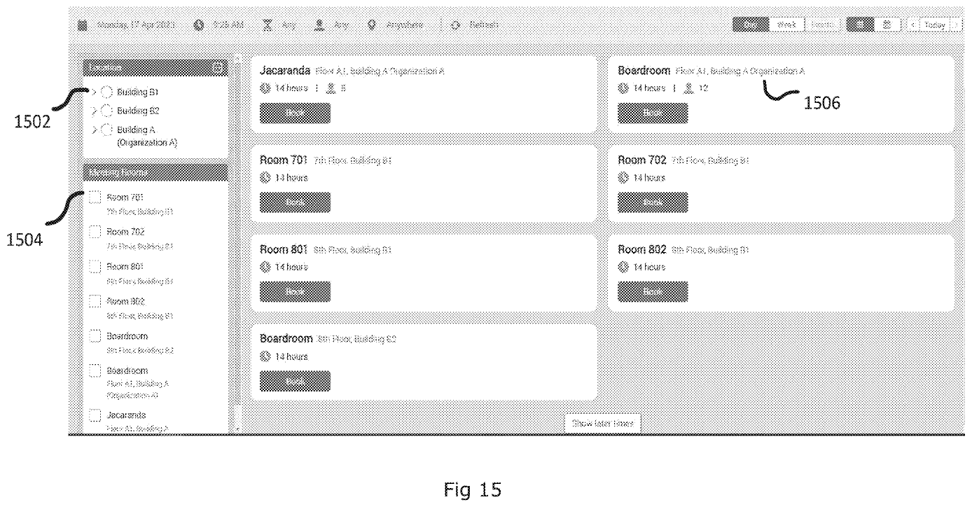

A requesting user from organization B is provided with functionality to view and search the available physical office resources via the GUI, see illustrative example shown in FIG. 15. The physical office resources include those of organization A, which are shared with the user of organization B. For instance, element 1506 in FIG. 15 illustrates a “Boardroom” resource belonging to organization A that is available for access to users of organization B. In the VLH in FIG. 15, element 1506 provides a “hierarchical slice” for the shared boardroom resource, which includes the location information of the resource, specifically “Floor A1, Building A, Organization A”. This facilitates the requesting user with the necessary navigation information for the shared location, and at the same time preventing physical office resources not shared by organization A from being accessible to the requesting user, consistent with the explanation on the concept of hierarchical slice section above.

### Embodiment Example 2—Controlling User Accessibility to Physical Office Resources Shared Between Four Organizations

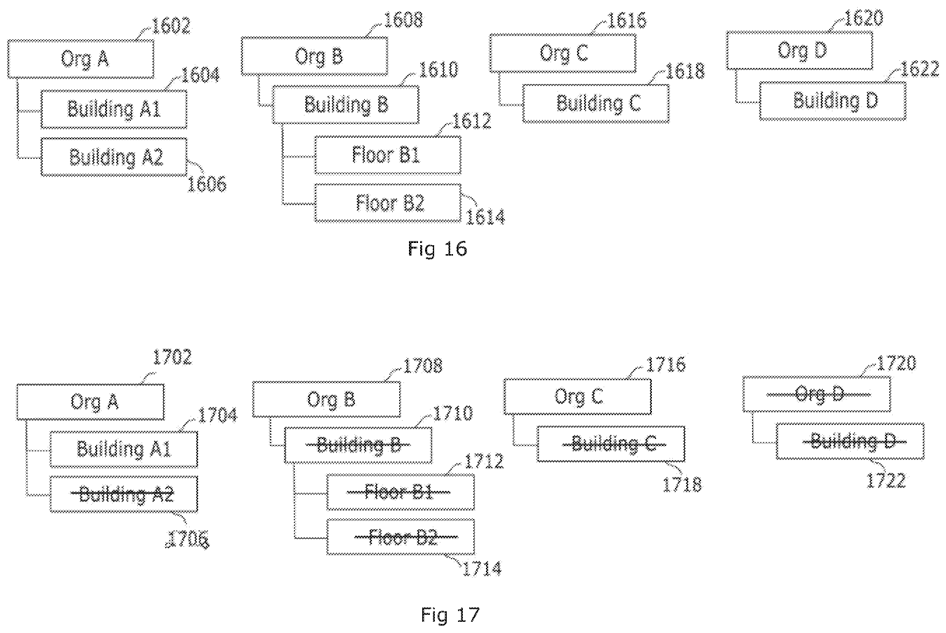

A further example embodiment for sharing (or making accessible) physical office resources belonging to multiple organizations; that is organizations A, B, C and D. The physical office resources belonging to each organization are illustrated in FIG. 16. In this example embodiment, purely for illustrative purposes, one or more of the organizations are set up to permit their respective physical office resources to be selectively made accessible by any one or more of the users of organizations A to D (i.e. those organizations participating in the sharing). The implementation of this example follows from system 100 and is consistent with those processing steps described in FIG. 9 and FIG. 14 embodiment example 1.

In the illustrative example of FIG. 16, the physical office resources of organization A are organised in a hierarchical structure based on the nested set model comprising two buildings, buildings A1 and A2. The physical office resources of organization B are also organised in a hierarchical structure based on the nested set model comprising two floors, floors B1 and B2 located within a building B. In a similar manner, organization C and D each comprise one physical office resource, building C and building D respectively. As per implementation example 1, these hierarchical structures are stored as data elements within respective datasets in the server datastore 126 of the system 100 and/or organization datastores such as the organization A datastore 148.

In this illustrative example, organization A intends to allow users of organizations B and C to have access to resources within building A1, and separately, only users of organization B to have access to resources within building A2. Organization B intends to allow only users of organization A to have access to resources on Floor B1 of building B. Organization C does not intend to permit external access to any of its resources but would like to use resources of other organizations it can access. Organization D does not intend to participate in the sharing arrangement at all and wishes to remain wholly independent.

The various sharing relationships amongst the four organizations are first captured in the system by the creation of one or more sharing network configurations. A user with administrative rights, for example the super administrator(s) 180 of system 100, creates an initial sharing network configuration(s) in accordance with the steps discussed in implementation example 1. At this stage, of the process no physical office resources have yet been shared. The initial sharing network configuration merely shows which organizations are participating in the sharing, in this example, organizations A, B and C are members of one or more sharing network configurations and organization D does not intend to participate in the sharing network configuration. The number of sharing network configurations needed to be created to capture the various sharing relationships between the multiple organizations will depend on the complexity of the desired sharing relationships. The administrator and/or organization users define the best way to create the sharing networks configurations to accurately capture all sharing relationships using some or all the processes previously described.

The sharing intentions by organization A, B and C in the example embodiment are encoded into the system via the GUI as part of the application 126 by the administrator user of the respective organisation in accordance with the steps discussed in implementation example 1. In the example embodiment the various sharing relationships can be created using two sharing network configurations as discussed in the following.

FIG. 17 illustrates the first sharing network configuration required for the example embodiment of FIG. 16, which captures the sharing relationship between organizations A, B and C only with building A1 1704. Within this sharing network configuration, the sharing instructions or rules are configured such that physical resource building A1 can be viewed and resources therein booked by users of organizations A, B and C only. Since building A1 1704 belongs to organization A, by default, users of organization A will have access to it unless optional security restrictions are applied to particular users from within the described system or by access controls from sources external to the described system.

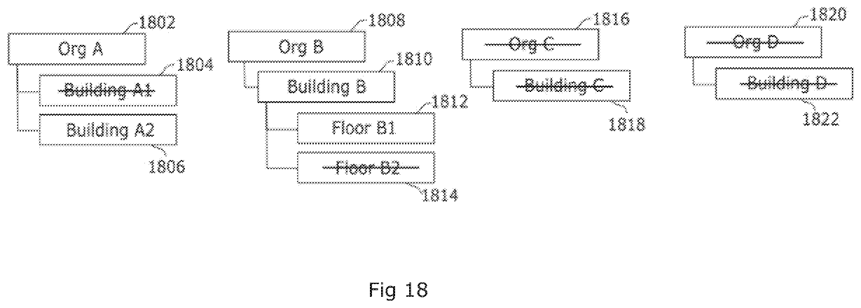

FIG. 18 illustrates the second sharing networks created for the example embodiment FIG. 16 to capture the sharing relationship between organizations A and B only with building A2 1806, and floor B1 1812 of building B.

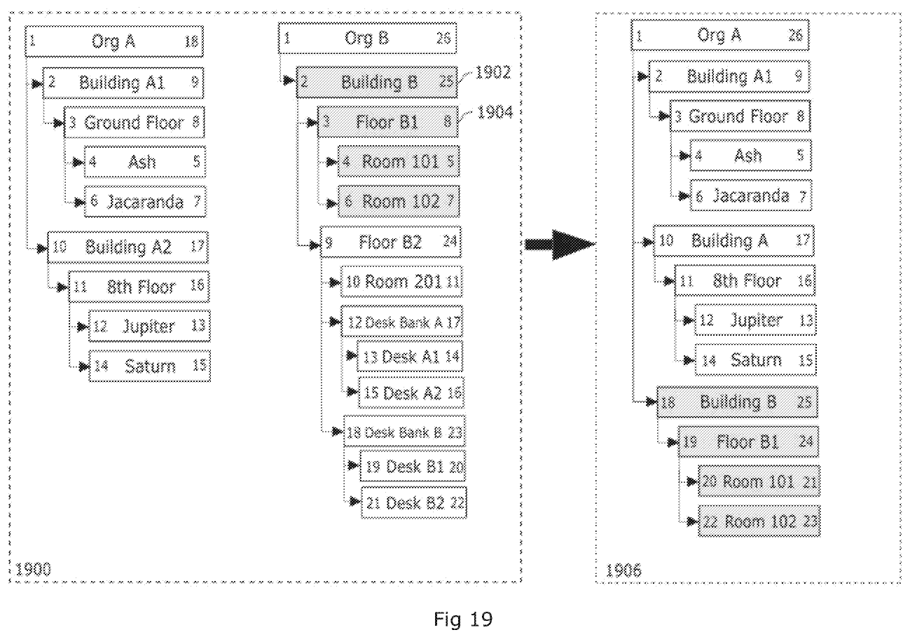

In accordance with the steps described in FIG. 9, the proposed system generates at runtime a VLH for a user of organization A. As illustrated in element 1906 of FIG. 19, information of the entirety of physical office resources of organization A is included in the VLH since the user requesting to view and book resources is from organization A. Merged with this data in the VLH is information of those office resources that are made available to view and book by organization B to the users of organization A, that is building B floor B1 1904. Thus, using the VLH generated in element 1906 of FIG. 19, the system will present to the user of organization A in the GUI merged resources of organization A and building B of organization B. From the user's perspective, the resources of building B would appear as though they were part of the resources of organization A.

### Other Variants

In one embodiment, the system 100 may establish one or more sharing network configurations between participating organizations without the involvement of a third-party facilitator, such as the super administrator(s) 180. In this embodiment, participating organizations agree offline as to what physical office resources they intend to share and how they intend to share them amongst each other. Within each participating organization, a requesting administrator user is first nominated. When a sharing agreement is reached, one or more requesting administrator users from the respective participating organization may initiate an invitation via the application 126 of the system 100 in accordance with the sharing agreement. This invitation is sent by the requesting administrator user in order to configure the necessary sharing relationships amongst the participating organizations required to meet the sharing agreement. Responsive to the invitation being accepted on the GUI of application 126 the system 100 establishes the sharing relationship requested by that invitation. The sharing agreement is only implemented when the invitations are accepted. The invitation sent by the respective requesting administrator user may include specific information relating to what and how physical office resources of the participating organizations should be shared. This feature is additional protection that enhances physical office resources not being inadvertently shared with other organizations. This also provides that the organizations involved have reviewed and approved the sharing permissions and relationships.

After the sharing network(s) is established, the system can generate a VLH for participating requesting users of the participating organizations in accordance with the processing steps in FIG. 9 and FIG. 14 of embodiment example 1. In this embodiment, the system is entirely self-governed and configured by the participating organisations whereby it does not involve a third-party facilitator, such as a super administrator, to configure the sharing network.

In one or more embodiments, the shared physical office resources, for example, desks, may be allocated a unique identifier using a sensor, QR code, RFID or such like. The sensor may be used to indicate the availability of a physical office resource, for example it may indicate occupancy. The status of the sensor may be monitored by application 126 of the system 100 at runtime. Therefore, the application 126 has full visibility of the status of resources that are available based on the status of the sensors. The sensors may be configured to communicate with the application 126 of the system 100 via the Internet, Zigbee, Bluetooth, Wi-Fi or such like. This feature may provide the requesting user flexibility of not needing to reserve a physical office resource prior to accessing the resource. The requesting user can utilise the location information provided by the hierachical slice in the GUI to locate the shared resource and choose to occupy the avilable resouce, for example, a particular desk upon arrival. Once occupied, the sensor detects occupancy and the application 126 is aware. VLH generated by subseqent requesting users will take this information into account.

Restricting Access of Sensitive Data from Unauthorised Requesting User

In at least one embodiment, when the application 126 generates at runtime a VLH for a requesting user, the user may be able to view one or more bookings of shared resources that have been previously created by users of other participating organizations as previously described in relation to FIG. 9. In order to avoid sensitive information relating to bookings made by users from the respective participating organizations being unintentionally accessible to the requesting user i.e. data leakage, the application 126 may remove from view such information.

In one example embodiment, if a user of organization A is viewing the VLH where a booking was previously made by a user of organization B, then the user of organization A can only see that a booking has been made but will not have access to sensitive information relating to purpose of the booking.

For example, a requesting user may have previously booked a physical office resource via the GUI. In doing so the system assigned an identifier to the selected resource to flag that it is no longer accessible by other users. The requesting user may have chosen to also include sensitive information relating to the purpose of the booking, such as specific details about the participants of a meeting, which the system stores as data elements in the datastore.

When a new requesting user requests a VLH to be generated, the application 126 of the system 100 first establishes to which participating organization the requesting user belongs to at runtime. If it is established using the application 126 that the requesting user is requesting to view resources not belonging to the requesting user's organization, the application generating the VLH will remove from view data elements comprising sensitive information relating to users of these organizations.

In another embodiment, the application may determine the level of authority of the requesting user. If it is established using the application 126 that the requesting user holds the authority to view data elements comprising sensitive information relating to users of these organizations, then the application generating the VLH at runtime may not remove from view said sensitive information from the VLH. For example, the requesting user may be able to unmask or make available the hidden sensitive information when selecting the prior booking.

### Generating Security Groups to Limit Access to Resources Shared by Other Organizations

In at least one embodiment, the sharing agreement may comprise a first organization sharing a suite of physical office resources with a second organization. The application 126 of the system 100 may allow the second organization to control access to the suite of resources shared physical office resources for the users of the second organization.

In order to provide this function a user administrator(s) of the second organization generates a security group using the application 126 of the system 100. The security group restricts access to the resources shared by the first organization to a select group of users from the users of the second organization.

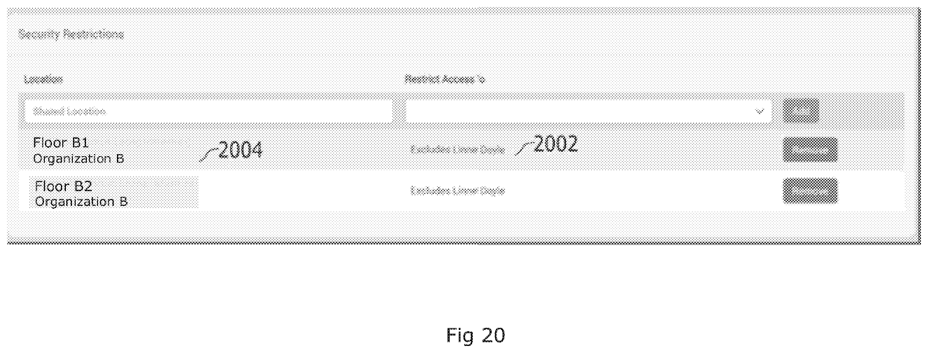

In one embodiment the application 126 of the system 100 provides a GUI to enable the user admin 152, 172 to generate a security group and create a sub-group of users that do have access to resources shared by the first organization. For example, element 2002 of FIG. 20 depicts the users that have restricted access to the shared resources, for example Floor B1 of organization B 2004 in FIG. 20.

This function may provide the second organization with greater flexibility and customization options, enabling the second organization to better tailor resource access to their specific needs. Furthermore, this function may enhance the security capabilities of the resource sharing system 100 in that the function enhances the restriction that only authorized users from the second organization have access to the shared resources, reducing the risk of unauthorized access and potential security breaches. Furthermore, the use of the application 126 of the system 100 for generating security groups and controlling access to shared resources simplifies the generated VLH for each requesting user. This enables only relevant physical office resources to be accessible to the requesting user depending on the requesting user's level of authority. This has the effect of lowering a user's cognitive burden thereby improving man-machine interaction.

Insofar as the disclosure described above is implementable, at least in part, using a machine readable instruction-controlled programmable processing device such as a general purpose processor or special-purposes processor, digital signal processor, microprocessor, or other processing device, data processing apparatus or computer system it will be appreciated that a computer program for configuring a programmable device, apparatus or system to implement the foregoing described methods, apparatus and system is envisaged as an aspect of the present disclosure and claimed subject matter. The computer program may be embodied as any suitable type of code, such as source code, object code, compiled code, interpreted code, executable code, static code, and or dynamic code, for example. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. The term “computer” in its most general sense may encompass programmable devices such as referred to above, and data processing apparatus and computer systems in whatever format they may arise, for example, desktop personal computer, laptop personal computer, tablet, smart phone or other computing device.

The computer program may be stored on a carrier medium in machine readable form, for example the carrier medium may comprise memory, removable or non-removable media, erasable or non-erasable media, writeable or re-writeable media, digital or analogue media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD) subscriber identity module, tape, cassette solid-state memory. The computer program may be supplied from a remote source and embodied in a communications medium such as an electronic signal, radio frequency carrier wave or optical carrier waves. Such carrier media are also envisaged as aspects of the present disclosure.

As used herein any reference to “one disclosure” or “a disclosure” means that a particular element, feature, structure, or characteristic described in connection with the disclosure is included in at least one disclosure. The appearances of the phrase “in one disclosure” or the phrase “in a disclosure” in various places in the specification are not necessarily all referring to the same disclosure.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the disclosure. This is done merely for convenience and to give a general sense of the disclosure. This description should be read to include one or at least one and the singular also includes the plural unless it is obvious that it is meant otherwise.

Various modifications may be made within the scope of the disclosure.

The scope of the present disclosure includes any novel feature or combination of features disclosed therein either explicitly or implicitly or any generalisation thereof irrespective of whether or not it relates to the claimed subject matter or mitigates against any or all of the issues addressed by the present disclosure. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

Moreover, example embodiments of the present disclosure are set forth in the following clauses. Although the following clauses describe example implementations, other implementations or embodiments are also encompassed by the present disclosure.

Clause 1—A method for operating a system to control user rights to view data elements identifying physical resources shared by one or more organizations, comprising: storing in a datastore of the system, a first dataset comprising first dataset elements identifying a first organization, a first parent physical resource, a first child physical resource of the first parent physical resource, the first dataset elements configured based on a first hierarchical relationship model, for representing the first child physical resources as being lower in the hierarchy than the first parent physical resource, and wherein the first dataset comprises location information of the physical resources of the first organization of the system; storing in the datastore of the system, a second dataset comprising second dataset elements identifying a second organization, a second parent physical resource, a second child physical resource of the second parent physical resource, the second dataset elements configured based on a second hierarchical relationship model, for representing the second child physical resources as being lower in the hierarchy than the second parent physical resource and wherein the second dataset comprises location information of the respective physical resources of the second organization of the system.

Clause 2—A method according to clause 1, further comprising: receiving a user input comprising information of the physical resources to be shared by the one or more organizations; generating a sharing network configuration comprising rules for providing the user rights to view data elements identifying physical resources shared by the one or more organizations based on the user input: determining a virtual location hierarchy responsive to the system receiving a request from a requesting user of the first organization to view data elements identifying physical resources shared by one or more organizations, the determining comprising: generating, using the sharing network configuration and the second dataset, a third dataset comprising data elements identifying the physical resources and associated locations shared by the second organization, wherein the identification is based on the second hierarchical relationship model and the third dataset is a subset of the second dataset; generating the virtual location hierarchy by combining the first and third datasets; and generating a graphical user interface to display the virtual location hierarchy for the requesting user to view data elements identifying physical resources shared by one or more organizations on the graphical user interface.

Clause 3—A method for operating a system to control user rights to view data elements identifying physical resources shared by one or more organizations, the system comprising: a datastore; a processor; a graphical user interface: the datastore comprising a first dataset comprising first dataset elements identifying a first organization, a first parent physical resource, a first child physical resource of the first parent physical resource, the first dataset elements configured based on a first hierarchical relationship model, for representing the first child physical resources as being lower in the hierarchy than the first parent physical resource, and wherein the first dataset comprises location information of the physical resources of the first organization of the system; the datastore comprising a second dataset comprising second dataset elements identifying a second organization, a second parent physical resource, a second child physical resource of the second parent physical resource, the second dataset elements configured based on a second hierarchical relationship model, for representing the second child physical resources as being lower in the hierarchy than the second parent physical resource and wherein the second dataset comprises location information of the respective physical resources of the second organization of the system; the method comprising: receiving a user input comprising information of the physical resources to be shared by the one or more organizations; generating a sharing network configuration comprising rules for providing the user rights to view data elements identifying physical resources shared by the one or more organizations based on the user input: determining a virtual location hierarchy responsive to the system receiving a request from a requesting user of the first organization to view data elements identifying physical resources shared by one or more organizations, the determining comprising: generating, using the sharing network configuration and the second dataset, a third dataset comprising data elements identifying the physical resources and associated locations shared by the second organization, wherein the identification is based on the second hierarchical relationship model and the third dataset is a subset of the second dataset; generating the virtual location hierarchy by combining the first and third datasets; and generating a graphical user interface to display the virtual location hierarchy for the requesting user to view data elements identifying physical resources shared by one or more organizations on the graphical user interface.

Clause 4—A method according to clause 2 or 3, further comprising: determining a virtual location hierarchy responsive to the system receiving a request from a user of the second organization to view data elements identifying physical resources shared by one or more organizations, the determining comprising: generating, using the sharing network configuration and the first dataset, a third dataset comprising data elements identifying the physical resources and associated locations shared by the first organization, wherein the identification is based on the first hierarchical relationship model and the fourth dataset is a subset of the first dataset; generating the virtual location hierarchy by combining the second and fourth datasets.

Clause 5—A method according to clause 2 or 3, further comprising: restricting user rights to view data elements identifying one or more of the physical resources shared by the second organization within the third dataset to a subgroup of users of the first organization, comprising: receiving user input from the first organization comprising information relating to one or more users within the first organization; generating a subgroup of users comprising the one or more users of the first organization based on the user input; generating a security group comprising rules for enabling the subgroup of users within the first organization rights to view data elements identifying physical resources shared by the second organization.

Clause 6—A method according to any of clause 4, further comprising: restricting user rights to view data elements identifying one or more of the physical resources shared by the first organization within the fourth dataset to a subgroup of users of the second organization, comprising: receiving user input from the second organization comprising information relating to one or more users within the second organization; generating a subgroup of users comprising the one or more users of the second organization based on the user input; generating a security group comprising rules for enabling the subgroup of users within the second organization rights to view data elements identifying physical resources shared by the first organization.

Clause 7—A method according to any preceding clause, further comprising: identifying the category of each physical resource within the first and second datasets by comparing each data element identifying the physical resources with a predetermined category within a look-up table, allocating an identifier to each physical resource type identified; storing within the datastore of the system, data elements identifying the physical resources comprising identifiers of the respective categories.

Clause 8—A method according to any preceding clause, wherein the hierarchical model may comprise one of a nested set model, a nested interval model, an adjacency list model, a closure table model, and a path enumeration model.

Clause 9—A method according to any preceding clause, further comprising: enabling the requesting user to obtain exclusive access to the data elements identifying the one or more of the physical resources displayed by the GUI, the enabling comprising: detecting an input to the graphical user interface from the requesting user to make a request for exclusive access to the one or more data elements identifying the physical resources; setting an identifier for a selected data element or respective selected data elements to identify the one or more physical resources that are exclusively accessible by the requesting user; and assigning to the identifier data elements representing information relating to the request for exclusive access.

Clause 10—A method according to clause 9, further comprising: receiving a request to generate a further virtual location hierarchy from a further requesting user; responsive to determining that the further requesting user and the requesting user are not from the same organization, restricting from view the data elements representing information relating to the request for exclusive access.

Clause 11—A method according to any preceding clause wherein the physical resource is a physical office resource.

Clause 12—A system for controlling user rights to view data elements identifying physical resources shared by one or more organizations, comprising: a datastore; a processor; a graphical user interface; the system configured to: store in a datastore of the system, a first dataset comprising first dataset elements identifying a first organization, a first parent physical resource, a first child physical resource of the first parent physical resource, the first dataset elements configured based on a first hierarchical relationship model, for representing the first child physical resources as being lower in the hierarchy than the first parent physical resource, and wherein the first dataset comprises location information of the physical resources of the first organization of the system; store in the datastore of the system, a second dataset comprising second dataset elements identifying a second organization, a second parent physical resource, a second child physical resource of the second parent physical resource, the second dataset elements configured based on a second hierarchical relationship model, for representing the second child physical resources as being lower in the hierarchy than the second parent physical resource and wherein the second dataset comprises location information of the respective physical resources of the second organization of the system; receive a user input comprising information of the physical resources to be shared by the one or more organizations; generate a sharing network configuration comprising rules for providing the user rights to view data elements identifying physical resources shared by the one or more organizations based on the user input: determine a virtual location hierarchy responsive to the system receiving a request from a requesting user of the first organization to view data elements identifying physical resources shared by one or more organizations, the determining comprising: generating, using the sharing network configuration and the second dataset, a third dataset comprising data elements identifying the physical resources and associated locations shared by the second organization, wherein the identification is based on the second hierarchical relationship model and the third dataset is a subset of the second dataset; generating the virtual location hierarchy by combining the first and third datasets; and generating a graphical user interface to display the virtual location hierarchy for the requesting user to view data elements identifying physical resources shared by one or more organizations on the graphical user interface.

Clause 13—A system according to clause 12, further configured to: determine a virtual location hierarchy responsive to the system receiving a request from a user of the second organization to view data elements identifying physical resources shared by one or more organizations, the determining comprising: generate, using the sharing network configuration and the first dataset, a fourth dataset comprising data elements identifying the physical resources and associated locations shared by the first organization, wherein the identification is based on the first hierarchical relationship model and the fourth dataset is a subset of the first dataset; generate the virtual location hierarchy by combining the second and fourth datasets.

Clause 14—A system according to clause 12, further configured to: restrict user rights to view data elements identifying one or more of the physical resources shared by the second organization within the third dataset to a subgroup of users of the first organization, comprising: receive user input from the first organization comprising information relating to one or more users within the first organization; generate a subgroup of users comprising the one or more users of the first organization based on the user input; generate a security group comprising rules for preventing the subgroup of users within the first organization rights to view data elements identifying physical resources shared by the second organization.

Clause 15—A system according to clause 13, further configured to: restrict user rights to view data elements identifying one or more of the physical resources shared by the first organization within the fourth dataset to a subgroup of users of the second organization, comprising: receive user input from the second organization comprising information relating to one or more users within the second organization; generate a subgroup of users comprising the one or more users of the second organization based on the user input; generate a security group comprising rules for preventing the subgroup of users within the second organization rights to view data elements identifying physical resources shared by the first organization.

Clause 16—A system according to any preceding clause, further configured to: identify the category of each physical resource within the first and second datasets by comparing each data element identifying the physical resources with a predetermined category within a look-up table, allocating an identifier to each physical resource type identified; store within the datastore of the system, data elements identifying the physical resources comprising identifiers of the respective categories.

Clause 17—A system according to any preceding clause, wherein the hierarchical model may comprise one of a nested set model, a nested interval model, an adjacency list model, a closure table model and a path enumeration model.

Clause 18—A system according to any preceding clause, further configured to: enable the requesting user to obtain exclusive access to the data elements identifying the one or more of the physical resources displayed by the GUI, the enabling comprising: detect an input to the graphical user interface from the requesting user to make a request for exclusive access to the one or more data elements identifying the physical resources; set an identifier for a selected data element or respective selected data elements to identify the one or more physical resources that are exclusively accessible by the requesting user; and include data elements representing information relating to the request for exclusive access to the selected data elements identifying the one or more physical resources that are exclusively accessible by the requesting user, in the identifier.

Clause 19—A system according to clause 18, further configured to: receive a request to generate a further virtual location hierarchy from a further requesting user; determine if the physical resource selected by the requesting user for exclusive access belongs to the same organization as the further requesting user; responsive to determining that they are not from the same organization, restrict the data elements representing information relating to the request for exclusive access to the selected data elements identifying the one or more physical resources that are exclusively accessible by the requesting user, in the identifier.

Clause 20—A system according to any one of clauses 12 to 19, wherein the physical resource is a physical office resource.

1. A method for operating a system to control user rights to view data elements identifying physical resources shared by one or more organizations, comprising:
storing in a datastore of the system, a first dataset comprising first dataset elements identifying a first organization, a first parent physical resource, a first child physical resource of the first parent physical resource, the first dataset elements configured based on a first hierarchical relationship model, for representing the first child physical resources as being lower in the hierarchy than the first parent physical resource, and wherein the first dataset comprises location information of the physical resources of the first organization of the system;
storing in the datastore of the system, a second dataset comprising second dataset elements identifying a second organization, a second parent physical resource, a second child physical resource of the second parent physical resource, the second dataset elements configured based on a second hierarchical relationship model, for representing the second child physical resources as being lower in the hierarchy than the second parent physical resource and wherein the second dataset comprises location information of the respective physical resources of the second organization of the system.

2. A method for operating a system to control user rights to view data elements identifying physical resources shared by one or more organizations, the system comprising:
a datastore;
a processor;
a graphical user interface:
the datastore comprising a first dataset comprising first dataset elements identifying a first organization, a first parent physical resource, a first child physical resource of the first parent physical resource, the first dataset elements configured based on a first hierarchical relationship model, for representing the first child physical resources as being lower in the hierarchy than the first parent physical resource, and wherein the first dataset comprises location information of the physical resources of the first organization of the system;
the datastore comprising a second dataset comprising second dataset elements identifying a second organization, a second parent physical resource, a second child physical resource of the second parent physical resource, the second dataset elements configured based on a second hierarchical relationship model, for representing the second child physical resources as being lower in the hierarchy than the second parent physical resource and wherein the second dataset comprises location information of the respective physical resources of the second organization of the system;
the method comprising:
receiving a user input comprising information of the physical resources to be shared by the one or more organizations;
generating a sharing network configuration comprising rules for providing the user rights to view data elements identifying physical resources shared by the one or more organizations based on the user input:
determining a virtual location hierarchy responsive to the system receiving a request from a requesting user of the first organization to view data elements identifying physical resources shared by one or more organizations, the determining comprising:
generating, using the sharing network configuration and the second dataset, a third dataset comprising data elements identifying the physical resources and associated locations shared by the second organization, wherein the identification is based on the second hierarchical relationship model and the third dataset is a subset of the second dataset;
generating the virtual location hierarchy by combining the first and third datasets; and
generating a graphical user interface to display the virtual location hierarchy for the requesting user to view data elements identifying physical resources shared by one or more organizations on the graphical user interface.

3. A system for controlling user rights to view data elements identifying physical resources shared by one or more organizations, comprising:
a datastore;
a processor;
a graphical user interface; the system configured to:
store in a datastore of the system, a first dataset comprising first dataset elements identifying a first organization, a first parent physical resource, a first child physical resource of the first parent physical resource, the first dataset elements configured based on a first hierarchical relationship model, for representing the first child physical resources as being lower in the hierarchy than the first parent physical resource, and wherein the first dataset comprises location information of the physical resources of the first organization of the system;
store in the datastore of the system, a second dataset comprising second dataset elements identifying a second organization, a second parent physical resource, a second child physical resource of the second parent physical resource, the second dataset elements configured based on a second hierarchical relationship model, for representing the second child physical resources as being lower in the hierarchy than the second parent physical resource and wherein the second dataset comprises location information of the respective physical resources of the second organization of the system;
receive a user input comprising information of the physical resources to be shared by the one or more organizations;
generate a sharing network configuration comprising rules for providing the user rights to view data elements identifying physical resources shared by the one or more organizations based on the user input:
determine a virtual location hierarchy responsive to the system receiving a request from a requesting user of the first organization to view data elements identifying physical resources shared by one or more organizations, the determining comprising:
generating, using the sharing network configuration and the second dataset, a third dataset comprising data elements identifying the physical resources and associated locations shared by the second organization, wherein the identification is based on the second hierarchical relationship model and the third dataset is a subset of the second dataset;
generating the virtual location hierarchy by combining the first and third datasets; and
generating a graphical user interface to display the virtual location hierarchy for the requesting user to view data elements identifying physical
resources shared by one or more organizations on the graphical user interface.
